(19) United States
(12) Patent Application Publication
(10) Pub. No.: US 2006/0019062 A1
(43) Pub. Date: Jan. 26, 2006

(54) Composite for storm protection

(76) Inventors: Jeffrey Alan Hanks, Midlothian, VA (US); Gary Douglas Milosovich, Chesterfield, VA (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/232,539

(22) Filed: Sep. 22, 2005

Related U.S. Application Data
(63) Continuation of application No. 10/308,492, filed on Dec. 3, 2002.

(51) Int. Cl. B32B 27/12; B32B 3/12; B32B 5/18

(52) U.S. Cl. 428/116; 428/911; 428/304.4; 428/317.9; 428/318.4; 428/537.1; 442/286; 442/315; 442/226; 442/394; 442/413

(57) ABSTRACT

A composite suitable as an integral portion of a building affording protection from wind blown debris such as from a tornado comprises in order a lightweight material, a layer of fabric of high strength fibers bonded with a resin and a layer of a structural sheathing material such as plywood.

### TECHNICAL FIELD

The invention relates to the use of a high strength composite sheathing for the reinforcement of walls and doors to resist penetration by wind-borne debris such as that generated by severe storm events, particularly tornadoes.

### BACKGROUND OF THE INVENTION

Storm shelters and cellars are necessary to provide a safe haven for protection against severe storm events in regions prone to tornado or hurricane activity. These shelters have been typically constructed of poured concrete, steel reinforced masonry, or heavy weight sheet metal. Details of adequate designs for storm shelters and cellars are detailed in publications from the Federal Emergency Management Agency (FEMA) such as Taking Shelter from the Storm—Publication 320 and Design and Construction Guidance for Community Shelters—Publication 361. The current designs rely on the use of common heavyweight construction materials such as concrete and steel to provide the resistance to wind-borne debris generated in the storm event.

The current designs are not easily incorporated into current building practices, and result in significant weight increases in the wall structure. The wood framing approaches described in FEMA Publication 320 require the in-filling of the wall section with solid masonry or continuous sheathing with 14 gauge steel plate. Doors for these shelters required the reinforcement with a minimum 14 gauge sheet metal to provide the needed penetration resistance. These approaches are cumbersome, difficult to install and difficult to field work to size. In regards to doors, the current solutions result in heavyweight doors that introduce safety issues and poor aesthetics.

A report dated May 31, 2000 by Clemson University submitted to the Federal Emergency Management Agency entitled “Enhanced Protection for Severe Wind Storms” describes several additional approaches for the reinforcement of shelter walls against wind-borne debris. Concepts included 4 walls (numbers 9, 10, 11 & 17) that made use of Kevlar® cloth. FIG. 12 on page 36 shows that these flexible cloth concepts provided no more than 44% of the impact resistance required to meet the “National Performance Criteria for Tornado Shelters”. No concept proposed in this study provided more than 60% of the requirements.

A substantial need exists for a method to reinforce walls and doors using lightweight field friendly materials to provide protection from wind-borne debris such as that generated in tornadoes and hurricanes. However wind speeds generated by tornadoes can exceed 200 miles per hour which is greatly in excess of wind speeds generated by hurricanes. Therefore a particular need exists for lightweight field workable sheathing to withstand wind-borne debris generated by the higher tornado wind speeds.

### SUMMARY OF THE INVENTION

The present invention is directed to:
a composite comprising in order:
(a) a layer of material having a density not greater than 0.25 grams per cubic centimeter,
(b) a layer of a fabric containing high strength fibers bonded with a resin,
(c) a layer of structural sheathing.
   wherein the fabric layer will deflect in a range from 5.0 to 17.5 centimeters when impacted by a 33 kilogram (15 pound) projectile at a speed of 161 kilometers (100 miles) per hour in accordance with ASTM test procedure E1886-97 with said composite mounted mounted on a rigid frame.

In a preferred embodiment of the invention the composite comprises in order:
(a) a layer of structural sheathing,
(b) a layer of material having a density not greater than 0.10 grams per cubic centimeter,
(c) a layer of a fabric containing high strength fibers bonded with a resin.
(d) a layer of structural sheathing.
   wherein the bonded fabric layer will deflect in a range from 5.0 to 17.5 centimeters employing a 33 kilogram (15 pound) projectile at a speed of 161 kilometers (100 miles) per hour in accordance with ASTM test procedure E1886-97 mounted on a rigid frame.

The composite is particularly adapted for construction of storm shelters and residences located in areas of the world which are subjected to wind-blown debris not only by hurricanes but also from the substantially higher wind speeds of tornadoes.

### DETAILED DESCRIPTION OF THE INVENTION

The present invention is an improvement in formation of a composite employing a high strength deflection layer as defined in the Summary of the Invention. Although the high strength deflection layer in combination with structural sheathing is highly effective in providing protection against wind blown debris, framing timbers within the supporting wall can affect the efficiency of the high strength deflection layer.

The present invention provides an improvement in the degree of protection which can be obtained through the use of a layer of a lightweight material adjacent the high strength deflection layer. This layer provides an unobstructed deflection region in which to deform.

In formation of a material of construction for protection against wind-blown debris such as generated by tornadoes with wind speeds in excess of 200 miles per hour a necessary starting material is a fabric containing high strength fiber. The fabric may be a woven or non-woven although a woven fabric is preferred. High strength fibers are well known and as employed herein means fibers having a tenacity of at least 10 grams per dtex and a tensile modulus of at least 150 grams per dtex. Yarns can be made from fibers such as aramids, polyolefins, polybenzoxazole, polybenzothiazole, glass and the like, and may be made from mixtures of such yarns.

The fabric may include up to 100 percent aramid fiber. By “aramid” is meant a polyamide wherein at least 85% of the am ide (—CO—NH—) linkages are attached directly to two aromatic rings. Examples of aramid fibers are described in Man-Made Fibers—Science and Technology 1 Volume 2, Section titled Fiber-Forming Aromatic Polyamides, page 297, W. Black et al., Interscience Publishers, 1968. Aramid fibers are, also, disclosed in U.S. Pat. Nos. 4,172,938; 3,869,429; 3,819,587; 3,673,143; 3,354,127; and 3,094,511.

Para-aramids are common polymers in aramid yarn and poly(p-phenylene terephthalamide) (PPD-T) is a common para-aramid. By PPD-T is meant the homopolymer resulting from mole-for-mole polymerization of p-phenylene diamine and terephthaloyl chloride and, also, copolymers resulting from incorporation of small amounts of other diamines with the p-phenylene diamine and of small amounts of other diacid chlorides with the terephthaloyl chloride. As a general rule, other diamines and other diacid chlorides can be used in amounts up to as much as about 10 mole percent of the p-phenylene diamine or the terephthaloyl chloride, or perhaps slightly higher, provided only that the other diamines and diacid chlorides have no reactive groups which interfere with the polymerization reaction. PPD-T, also, means copolymers resulting from incorporation of other aromatic diamines and other aromatic diacid chlorides such as, for example, 2,6-naphthaloylchloride or chloro- or dichloroterephthaloyl chloride or 3,4-diaminodiphenylether.

By “polyolefin” is meant polyethylene or polypropylene. By polyethylene is meant a predominantly linear polyethylene material of preferably more than one million molecular weight that may contain minor amounts of chain branching or co-monomers not exceeding 5 modifying units per 100 main chain carbon atoms, and that may also contain admixed therewith not more than about 50 weight percent of one or more polymeric additives such as alkene-1-polymers,in particular low density polyethylene, propylene, and the like, or low molecular weight additives such as anti-oxidants, lubricants, ultra-violet screening agents, colorants and the like which are commonly incorporated. Such is commonly known as extended chain polyethylene (ECPE). Similarly, polypropylene is a predominantly linear polypropylene material of preferably more than one million molecular weight. High molecular weight linear polyolefin fibers are commercially available.

Polybenzoxazole and polybenzothiazole are preferably made up of polymers of the following structures:

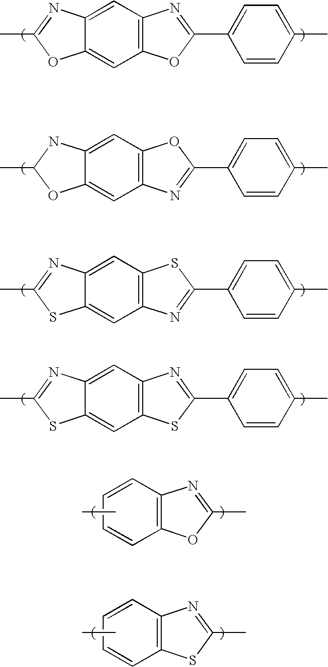

While the aromatic group shown joined to the nitrogen atoms may be heterocyclic, they are preferably carbocyclic; and while they may be fused or unfused polycyclic systems, they are preferably single six-membered rings. While the group shown in the main chain of the bis-azoles is the preferred para-phenylene group, that group may be replaced by any divalent organic group which does not interfere with preparation of the polymer, or no group at all. For example, that group may be aliphatic up to twelve carbon atoms, tolylene, biphenylen, bis-phenylene either, and the like.

A further requirement in the present invention is the use of a resin to bind individual fibers of the high strength fibers in the employed fabric. The resin may be selected from a wide variety of components such as polyethylene, ionomers, polypropylene, nylon, polyester, vinyl ester, epoxy and phenolics and thermoplastic elastomers.

The resin may be applied to the fabric containing high strength fibers by coating or impregnation, such as under pressure.

However, criticality exists in the present invention in the combination of fabric with high strength fibers/resin combination. It has been discovered that this combination must have the ability to deflect within certain parameters when securely fastened to a support structure.

Accordingly, the high strength fabric/resin combination must have an ability for deflection within the layered composite when tested in accordance with National Performance Criteria for Tornado Shelters, First Addition, FEMA, May 28,1999 using ASTM Test Method E1886-97, entitled “Standard Test Method for Performance of Exterior Window, Certain Walls, Doors and Storm Shutters Impacted by Missile(s) and Exposed to Cyclic Pressure Differentials.” Highlights of the test include mounting the test specimen, impacting the specimen with a 33 kilogram (15 pound) 2×4 missile propelled at a speed of 161 kilometers (100 miles) per hour and observing and measuring the test results. The ASTM test procedure E1886-97 is specific to the various requirements such as the use of 2×4 lumber missile, missile propulsion device, speed measuring system and use of a high speed video or photographic camera. It is understood, herein, that the test procedure for purposes of the present disclosure, involves attaching any test specimen to a suitable support frame, in such a way that is representative of an actual wall installation. Such specimen is then impacted on the plywood face at or near the center of the panel. The 2×4 lumber missile should be marked with suitable indexing marks to allow the tracking of the depth of penetration of the projectile. The photographic or video camera should be positioned to monitor the depth of penetration of the projectile and such camera should have a minimum frame rate of 1000 frames per second.

In accordance with the described test procedure, the combination of the fabric containing high strength fibers bonded with a resin will deflect within a range from 5.0 to 17.5 cm. More preferably, the deflection will be in a range from 8.0 to 16.0 cm and most preferably 10.0 to 15.0 cm. The degree of deflection may be determined by its final use in a building structure. Illustratively, a maximum stated deflection of the fabric/resin combination may be undesirable in a residence due to the proximity of an occupant adjacent a wall containing the cloth/resin combination. However, a minimum deflection within the above range can require an added thickness of the fabric resulting in a high cost of construction. As employed herein, fabric is inclusive of more than one layer of a cloth. As employed herein deflection means the maximum measured distance of separation of the high strength fabric/resin combination from the structural sheathing. It is understood that the measurement must be undertaken in conjunction with high speed photography. For purposes of illustration for deflection measurement, if during the test procedure with the projectile, there may be some bowing of the structural sheathing. The measurement for deflection is the distance, i.e., the separation, of the high strength fabric/resin combination from the bowed portion of the sheathing. It can be determined from review of the photographic or video record collected during previously described testing, determining the maximum depth of penetration during the event, and subtracting the thickness of the structural sheathing.

The use of a fabric containing high strength fibers, i.e., Kevlar® aramid in combination with plywood has been previously tested in the Clemson University report referenced in the Background of the Invention. However in accordance with the test procedure of this report, complete penetration of the Kevlar® aramid/plywood took place with a nine pound projectile at a speed of 73 miles per hour.

In the present invention the combination of the fabric containing the high strength fibers/resin is for employment with a wood based or other structural sheathing material, since an additional purpose of the combination is the structural reinforcement of a wall or door. The term “structural sheathing” is inclusive of any material which provides structural building support. The preferred material is wood, particularly plywood, due to extensive use in the building industry. However other materials are known for structural sheathing serving as building support: a typical example is fiberboard reinforced with cement. The fabric/resin combination is generally flexible and will be employed with the sheathing which for purposes of illustration may be at least 0.65 cm (one quarter inch) and preferably for purposes of support, at least 1.27 cm (one half inch). The type of structural sheathing is not critical to the success of the present invention. The sheathing may be solid such as from hard or soft woods or may be in the form of a composite such as plywood or a non-wood sheathing such as cementous fiberboard. As a practical matter, it is believed that most uses of the present invention will be with plywood since it is a common material used in wall structures. There is no maximum thickness to the structural sheathing which in a building structure will be or face an outer wall with the combination of fabric/resin facing the inner portion of the building, i.e., for example a room where inhabitants are to be protected.

Therefore, in construction of a protective shelter or one or more rooms in a residence, it is intended that the structural sheathing face the direction of any wind-borne debris such that the debris strikes the wood with penetration before contact and containment with deflection of the combination of cloth/resin. It is understood that the invention is particularly advantageous since conventional building construction and techniques with structural sheathing may be employed.

It is noted that use of an aramid fiber/wood combination has been disclosed in German DE 195 12582 as claddings of walls, ceilings and floors in indoor firing ranges. However, the requirements of a firing range with a high speed/low weight projectile are entirely different than the requirements of the present invention with wall deflection and with an ability to stop penetration of wind-borne debris due to wind speed of over 200 miles per hour.

As previously set forth, the combination of the high strength deflection layer with the structural sheathing is effective in stopping wind blown debris. However, the deflection layer and structural sheathing are required to be supported, i.e., in building construction such as residential, the supporting material is typically wood while in commercial construction the supporting material is typically wood or metal.

Additionally, in residential construction, a support structure for the deflection layer and structural sheathing will typically be load bearing, i.e., aids to support a portion of the building, while in commercial construction the support may or may not be load bearing.

However, it has been found that the ability of the efficiency of the deflection layer and structural sheathing to withstand impact (such as from wind blown debris), can be affected by the load bearing supports.

In the present invention an improvement is present for impact or striking resistance through use of a lightweight material with the following composite construction present in order:
lightweight material
high strength deflection layer
structural sheathing.

The lightweight material will have a density of not greater than 0.25 grams per cubic centimeter, preferably, not greater than 0.10 grams per cubic centimeter, and more preferably, not greater than 0.05 grams per cubic centimeter.

The lightweight material may be flexible or rigid. However, it is within the scope of the present invention for rigidity to be provided by support or reinforcement. Therefore, the lightweight material may not be self-supporting but the overall lightweight material layer will have flexibility or rigidity through use of a support or reinforcement to provide this property. Therefore, in a preferred mode, the layer containing the lightweight material is self-supporting, i.e., it will not collapse. Illustratively, lightweight materials include, for example, polystyrene and polyurethane, which can be present as foams or honeycomb structures made, for example, from kraft paper, aramid paper, aluminum sheeting and plastic. The lightweight material can as well be a foam structure reinforced with light-gauge steel members or wires as described in U.S. Pat. No. 4,241,555.

The thickness of the lightweight material layer is not critical with an example in the range of 5.0 to 20.0 centimeters.

In a preferred embodiment of the invention a further structural sheathing layer will be employed so that the lightweight material is positioned as a core held in place by a further structural sheathing layer. In such case a composite will comprise in order:
structural sheathing
rigid lightweight material
high strength deflection layer
structural sheathing.

It is understood that the layers of structural sheathing need not be identical, and in many instances may vary. Examples of structural sheathing include wood such as plywood or wood composite, plastic composite, fiber cement and metal.

To further illustrate the present invention, the following examples are provided.

### EXAMPLE 1

A 47-in by 88-in composite wall panel was produced using in order 1 layer of ⅝-in plywood, a 5½ inch thick steel reinforced expanded polystyrene core with a density of 1 lb/cu-ft (0.016 gm/cc), a laminated fabric made from 3 layers of a 13 oz/sq-yd aramid cloth that was bonded together with a polyethlyene co-polymer resin and 1 layer of ⅝-in plywood. Steel reinforcement was done with 24-gauge 2×4 common metal framing studs on 16-inch centers that were laid flat on each face of the panel. Reinforcement was added during the foaming process as described in U.S. Pat. No. 4,241,555.

The wall panel was mounted on a rigid test frame with the 47-in dimension on each side of the wall panel fully supported on 10-inch structural beams to simulate installation between floors or floor-to-roof in a building. The wall panel overlapped this beam by 4-inches on each end. The sample was impacted with a 15-lb 2×4 (inches) timber projectile traveling at 100 mph, to assess ability to meet the “Windborne Missile Impact Resistance on Shelter Wall and Ceiling” provisions of the National Performance Criteria for Tornado Shelters, First Addition, FEMA, May 28, 1999. Cannon set-up and firing was done in accordance with ASTM E 1886-97.

The wall segment stopped the projectile from passing through it as required by the FEMA provisions, and the projectile was rebounded back. High speed photography taken during the event showed the projectile to penetrate approximately into the wall cavity 5-inches before being rebounded back. Deflection of the composite sheathing was calculated to be 4.5-inches. The plywood layer on the outside of the wall showed damage only locally around the point of projectile entry. The plywood layer on the back side showed only very minor cracking around the impact point.

### EXAMPLE 2

A 48-in by 48-in composite wall panel was produced using in order 1 layer of ⅝-in plywood, a 5½ inch thick expanded polystyrene core with a density of 1 lb/cu-ft (0.016 gm/cc), a laminated fabric made from 2 layers of a 13 oz/sq-yd aramid fabric laminated bonded together with polyethlyene co-polymer resin, and a layer of ⅝-in plywood. The edges were framed with standard 2×6 inch wood studs that were used to nail plywood and laminated sheathing in place. Nailing was done around the perimeter with #10 power driven nails on 5-cm centers. A standard construction adhesive was applied between the wood faces, the bonded fabric layer, and foam layer to create the rigid panel.

The wall panel was mounted on a rigid test frame with 2-sides of the panel fully supported on 10-in structural steel beams to simulate installation between floors or floor-to-roof in a building. The wall panel overlapped the beams by 4-inches on each end. The sample was impacted with a 15-lb 2×4 timber projectile traveling at 100 mph, to assess ability to meet the “Windborne Missile Impact Resistance on Shelter Wall and Ceiling” provisions of the National Performance Criteria for Tornado Shelters, First Addition, FEMA, May 28, 1999. Cannon set-up and firing was done in accordance with ASTM E 1886-97.

The wall segment stopped the projectile from passing through it as required by the FEMA provisions, and the projectile was rebounded back. High speed photography taken during the event showed the projectile to penetrate approximately into the wall cavity 5.5-inches before being rebounded back. Deflection of the composite sheathing was calculated to be 5.0-inches. The plywood layer on the outside of the wall showed damage only locally around the point of projectile entry. The plywood layer on the back side showed only very minor cracking around the impact point.

### EXAMPLE 3 (COMPARATIVE EXAMPLE)

A 48-in by 48-in composite wall panel was produced using in order 1 layer of ⅝-in plywood, a laminated fabric made from 2 layers of a 13 oz/sq-yd aramid fabric laminated bonded together with polyethlyene co-polymer resin, a wooden frame structure built in accordance with with FEMA Publication 320, Revision 1 specific to Drawings AG-5 and 14 using 2×6 framing framing timbers versus 2×4 framing timbers. Nailing was done around the perimeter with #10 power driven nails on 5-cm centers and on field studs using 10-cm centers per the FEMA specification. A standard construction adhesive was applied between the framing timbers, bonded fabric layer and plywood facing to create the rigid panel.

The wall panel was mounted on a rigid test frame with 2-sides of the panel fully supported on 10-in structural steel beams to simulate installation between floors or floor-to-roof in building. The wall panel overlapped the beam by 4-inches on each end. Orientation of the specimen was such that the field studs spanned the 10-in structural beams. The sample was impacted With a 15-lb 2×4 timber projectile traveling at 100 mph, to assess ability to meet the “Windborne Missile Impact Resistance on Shelter Wall and Ceiling” provisions of the National Performance Criteria for Tornado Shelters, First Addition, FEMA, May 28, 1999. Cannon set-up and firing was done in accordance with ASTM E 1886-97.

The wall segment did not stop the projectile from passing through it as required by the FEMA provisions.

1. A composite comprising in order:
(a) a layer of material having a density not greater than 0.25 grams per cubic centimeter;
(b) a layer of a fabric containing high strength fibers bonded with a resin
(c) a layer of structural sheathing.
wherein the bonded fabric layer will deflect in a range from 5.0 to 17.5 centimeters when impacted with a 15 pound 2×4 lumber projectile at a speed of 161 kilometers (100 miles) per hour in accordance with ASTM test procedure E1886-97 mounted on a rigid frame.

2. The composite of claim 1 wherein the deflection is in a range from 8.0 to 16.0 centimeters.

3. The composite of claim 1 wherein the high strength fibers are selected from the group consisting of aramid fibers, glass fibers, polyethylene fibers, polyvinyl alcohol fibers, polyarylate fibers, polybenzazole fibers, or carbon fibers.

4. The composite of claim 1 wherein the high strength fibers comprise an aramid.

5. The composite of claim 1 wherein the high strength fibers are glass.

6. The composite of claim 1 wherein the structural sheathing is at a thickness of at least 0.65 centimeters (one quarter inch).

7. The composite of claim 1 wherein the structural sheathing comprises plywood.

8. The composite of claim 1 wherein layer (a) has a density not greater than 0.10 grams per cubic centimeter.

9. The composite of claim 1 wherein layer (a) is a foam.

10. The composite of claim 1 wherein layer (a) has a honeycomb or honeycomb-like structure.

11. The composite of claim 1 wherein layer (a) is rigid.

12. The composite of claim 1 wherein layer (a) is flexible.

13. The composite of claim 1 wherein layer (a) is reinforced.

14. A composite comprising in order:
(a) a layer of structural sheathing;
(b) a layer of material having a density not greater than 0.25 grams per cubic centimeter;
(c) a layer of a fabric containing high strength fibers bonded with a resin.
(d) a layer of structural sheathing.
wherein the bonded fabric layer will deflect in a range from 5.0 to 17.5 centimeters when impacted with a 15 pound 2×4 lumber projectile at a speed of 161 kilometers (100 miles) per hour in accordance with ASTM test procedure E1886-97 mounted on a rigid frame.

15. A building structure having an integral portion of the structure comprising:
(a) a layer of material having a density not greater than 0.25 grams per cubic centimeter;
(b) a layer of a fabric containing high strength fibers bonded with a resin.
(c) a layer of structural sheathing.
wherein the bonded fabric layer will deflect in a range from 5.0 to 17.5 centimeters when impacted with a 15 pound 2×4 lumber projectile at a speed of 161 kilometers (100 miles) per hour in accordance with ASTM test procedure E1886-97 mounted on a rigid frame

16. A building structure having an integral portion of the structure comprising:
(a) a layer of structural sheathing;
(b) a layer of material having a density not greater than 0.25 grams per cubic centimeter;
(c) a layer of a fabric containing high strength fibers bonded with a resin.
(d) a layer of structural sheathing.
wherein the bonded fabric layer will deflect in a range from 5.0 to 17.5 centimeters when impacted with a 15 pound 2×4 lumber projectile at a speed of 161 kilometers (100 miles) per hour in accordance with ASTM test procedure E1886-97 mounted on a rigid frame.
